(19) United States
(12) Patent Application Publication
(10) Pub. No.: US 2004/0147252 A1
(43) Pub. Date: Jul. 29, 2004

(54) Message handling

(76) Inventor: Patrik Strom, Sollentuna (SE)

Correspondence Address: NIXON & VANDERHYE, PC, 1100 N GLEBE ROAD, 8TH FLOOR, ARLINGTON, VA, 22201-4714, US

(21) Appl. No.: 10/471,787

(22) PCT Filed: Mar. 14, 2002
(86) PCT No.: PCT/SE02/00484

(30) Foreign Application Priority Data
Mar. 16, 2001 (SE) 0100943-0

(51) Int. Cl. H04M 3/00

(52) U.S. Cl. 455/418

(57) ABSTRACT

The invention relates to a method of and a device for sending messages to mobile stations in mobile networks without having to upgrade the mobile stations. The method comprises the steps of: programming the network to alert a specific mobile station when the mobile station passes within a predetermined range from a specific geographical location and associating information with the specific geographical location 100, associating an alert counter with a message information, which alert counter defines the number of passes the mobile station shall receive said message information, determining an actual geographical location of the mobile station by using the capability of the mobile network 200, and expressing on the mobile station whatever information the programmer chose to associate with the specific geographical location when the mobile station passes within a predetermined range from the specific geographical location 204.

### TECHNICAL FIELD OF THE INVENTION

The invention relates to a method of and a device for sending messages to mobile stations in mobile networks.

### DESCRIPTION OF RELATED ART

In the hectic world of today, it is advantageous if a person is automatically reminded of things to do when passing a particular location, e.g. to mail a letter when passing a mailbox, so that the person does not have to think on an up to date “to do” list all the time.

EP 1 008 946 A1 shows a mobile user device, such as a wireless telephone, equipped with a global positioning system (GPS) receiver. The device is programmable by the user to alert the user when he or she arrives with the device at a predetermined location, or within a predetermined range from a location, as well as to disclose to the user whatever information the user chose to associate with that location.

U.S. Pat. No. 5,848,373 A shows a computer aided map location system (CAMLS). A computer, e.g. a personal digital assistant (PDA), with a computer display may incorporate a GPS location system for displaying the location of the CAMLS user on the display. A user or another party can enter messages for the user such as “buy milk on the way home” or “pick up Suzy at day care”. The message is expressed on the users CAMLS PDA equipped with GPS as voice or text output, directly as a function of the user location, i.e. e.g. when approaching a specified destination or entering a predetermined unique CAMLS grid quadrangle.

These devices for automatically reminding a person of a thing to do when passing a predetermined location have the following disadvantages and limitations: Firstly, these devices need a GPS receiver unit incorporated in or attached to them which means that the end user must acquire new terminal equipment adapted to the systems, e.g. a wireless telephone equipped with a GPS receiver as in EP 1008 946 A, or a PDA with a GPS receiver interface as in U.S. Pat. No. 5,848,373 A. Secondly, a system that have the positioning capability, e.g. GPS, in the mobile station needs to have all mapdata stored in the mobile station. This will be very cumbersome, costly and demand large amounts of memory in the mobile station when travelling to a new destination, since the user will need to buy and install a new map database for each destination. Also the user would need to define “points of interest” for each new location, which might be difficult if it is the first visit.

### SUMMARY

The object of the invention is to bring about a method and a device relating to sending messages to mobile stations in mobile networks without having to upgrade the mobile stations, i.e. the mobile terminals such as mobile phones or other mobile devices functioning as mobile stations.

This is achieved by the use of a mobile network comprising means for sending a specific message to a specific mobile station in the mobile network based on geographical location, where the mobile network is used to determine the actual geographical location of the specific mobile station.

The method and device according to the invention has the following advantages: It is possible for a user, or any other person (if approved by the user), to send messages to mobile stations, including the users own mobile station, e.g. as a means for reminding himself or herself of things to do, in mobile networks without having to upgrade the mobile station hardware or software. The system works with all current models of mobile stations, since all the necessary hardware and software will reside at one place at the operator of the mobile network. No additional information such as a map database or a positioning receiver has to be added to the mobile station. All updates of map databases, “points of interest” etc. will be performed in the server based at the Operator of the mobile network without intervention of the users as long as the Operator of the mobile network at a given destination has deployed the Wireless Messaging (WM) service. The present invention uses the Mobile network to position the mobile station, and hence omits the need for a mobile station with this positioning capability built-in.

Acronyms and abbreviations

| | |
|---|---|
| API | Application Programmers Interface |
| AuC | Authentication Center |
| BSC | Base Station Controller |
| BTS | Base Transceiver Station |
| CGI | Cell Global Identity |
| EC | Emergency Center |
| EIR | Equipment Identity Register |
| GMPC | Gateway Mobile Positioning Center |
| GMSC | Gateway Mobile Switching Center |
| GPS | Global Positioning System |
| HLR | Home Location Register |
| HTTP | Hyper Text Transfer Protocol |
| ILR | Interworking Location Register |
| LCS | Location Services |
| MPC | Mobile Positioning Center |
| MPS | Mobile Positioning System |
| MS | Mobile Station |
| MSC | Mobile services Switching Center |
| MXE | Multimedia eXchange Environment |
| PLMN | Public Land Mobile Network |
| SMPC | Serving Mobile Positioning Center |
| SS7 | CCITT Signaling System 7 |
| TA | Timing Advance |
| VLR | Visited Location Register |
| WM | Wireless messaging |

### BRIEF DESCRIPTION OF THE DRAWINGS

The invention will be described in more detail below with reference to the appended drawings, wherein:

FIG. 1 shows a schematic block diagram of the switching system and the base station system in a mobile network according to the invention, and

FIG. 2 shows a schematic flow diagram of operations performed when programming the message tool, and of operations performed in a mobile network according to FIG. 1 when alerting a mobile station.

### DETAILED DESCRIPTION OF EMBODIMENTS

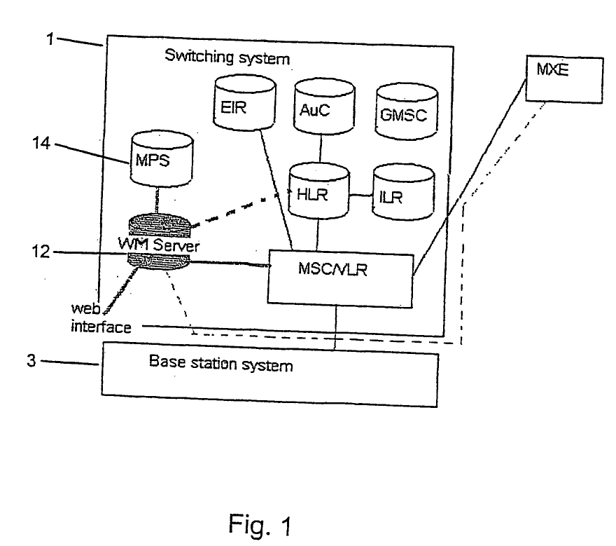

On the drawings, FIG. 1 shows a schematic block diagram of the switching system 1 and the base station system 3 in a digital GSM mobile telephone network according to one embodiment of the invention. The mobile network uses geographical location dependent reminder messaging based on a client-server solution where all the necessary additional hardware and software for the messaging, all of the intelligence, is in the mobile network, whereas the mobile terminal is a standard digital mobile terminal such as a mobile telephone or other mobile terminal, e.g. a computer with a GSM card.

The mobile network is used to determinate the actual geographical location of a specific mobile station, and thus also the geographical location of the user carrying the mobile station, and to send a specific message to the specific mobile station. This will work as a push-service based on geographical position.

The messaging application will run on a WM-server 12 which is added to the switching system 1 for the digital GSM mobile telephone network. The WM-server 12 communicates with a Mobile Positioning System (MPS) 14, also added to the switching system 1 for the digital GSM mobile telephone network, to find out the geographical location of the specific mobile station. This position update is done in real-time in order to be able to send the wireless message to the mobile station at the chosen location. A direct communication is necessary since the “work load” for the HLR and/or MSC/VLR in the GSM system would be to heavy.

A Mobile Positioning System (MPS) is a location system that determines the geographical position, i.e. geographical location, of mobile terminals and enables an operator to provide his customers with Location Services. Here the invention is exemplified using the Ericsson MPS 3.0 and the GSM network. With the Ericsson MPS 3.0 Mobile Positioning System all GSM mobile terminals can be used for positioning without any modifications. The positioning methods used in MPS 3.0 are standardised on the A-interface (MSC-BSC).

The Ericsson MPS 3.0 Mobile Positioning System (MPS) consists of a server based Mobile Positioning Centre (MPC) and software extensions for MSC, MSC/VLR, BSC and HLR, and is to a great extent based on the current solution for GSM systems.

The MPC consists of the Gateway Mobile Positioning Centre (GMPC) and Serving Mobile Positioning Centre (SMPC), and is the literal brain of the positioning system. It acts as a mediation device between a PLMN and the user applications. It handles all the positioning requests, calculates the geodetic position of the MS, and generates statistics. It basically administers the entire positioning system. The MPC system is a client/server solution consisting of the MPC server and the MPC Tool with a Graphical User Interface (GUI) that runs on any Java platform as client.

It is the MPC server that handles the communication with external systems to retrieve positioning data. The server is responsible for the positioning calculations as well as for the conversion of positioning data to different geodetic co-ordinate systems. MPC offers an interface through which user applications and the MPC server can communicate. The communication consists of positioning requests from the application and positioning answers from the MPC server. The MPC can handle connections from multiple applications simultaneously. The MPC Tool offers an easy to use interface for administration of the MPC server.

The GMPC and SMPC are logical nodes, and in small networks, they can be hosted on the same geographical server. The mobile position information in the form of Cell-id and Timing Advance (CGI+TA) is delivered to the MPC via the GSM network. The Gateway Mobile Positioning Centre (GMPC) receives positioning data, and performs necessary authentication. The SMPC calculates the actual position of the mobile user using the information obtained from the network. MPS contains, except for the GMPC and SMPC, also other components, for example an HTTP based positioning information user application interface. The M?C is connected to the network using SS7 signalling.

The positioning procedure is hosted in the SMPC and finds out and reports the positioning data of the terminal. The positioning procedure includes the signalling needed to communicate with the MPC and also the signalling between the different network elements.

To prevent illegal use non-authorised positioning and to support privacy, the GMPC has several checkpoints that must be passed before a position is retrieved:

1. The application connecting to the GMPC must be defined in the GMPC as a LCS client. It is the PLMN operator that administers which clients that can connect to the GMPC. The application identifies itself and logs on to the GMPC using a LCS client ID and a password.

2. The GMPC checks if the client is rated as an Emergency Center (EC). An EC is the place where a caller is connected to when dialing an emergency number. If it is an EC, no further checks are performed since the EC is allowed to position all terminals.

3. If it is not an EC, the GMPC verifies that the application is authorised to request positioning information for that particular user. The LCS client profiles are administered by the PLMN operator and contain information about which terminals each LCS client is allowed to position.

4. After passing all the checks, the GMPC requests routing information from the HLR and then sends a positioning request to the serving MSC.

5. In the serving MSC/VLR, the Positioning Allowed Indicator (PAI) flag, is checked. If not the PAI flag has been activated, the position will be terminated by the MSC/VLR. The flag allows the end user to tell if he/she permits positioning or not of the terminal. The flag can be overridden by an EC.

6. In case of an idle terminal the MSC/VLR first sets up a signalling call towards the terminal. By doing this, the CGI and TA value become available in the MSC. The CGI and the TA value is then sent to the Serving MPC inside the position request.

7. The SMPC translates the CGI and TA value to a geographical area. The position data is then sent to the GMPC via the MSC/VLR. The GMPC finally returns the terminal location information to the external application according to the API.

The positioning method in the MPS 3.0 release is based on the Timing Advance (TA) value from the serving cell. To find out the serving cell and the TA value when the mobile station (MS) is in idle mode, the system will initiate a paging process as if it tries to initiate a call to the MS. This means that the user of the MS will normally not be disturbed when he/she is being positioned. The only disturbance will be if the MS user at the very same time will try to make a call, or if someone is trying to call the MS. Ongoing calls are not disturbed, because when the MS is in dedicated mode (busy) Cell Global Identity and TA value is already available.

The geographical position of an MS is described as an arc (part of a circle) with a certain depth. The information given by the SMPC to describe the arc will be:

the centre of the arc (the location of the BTS) in longitude and latitude

the radius of the inner circle (the value is 0 if only CGI can be used for positioning)

The radius of the outer circle. If CGI is used, this value corresponds to the maximum range of the cell.

the start angle (0 for a omni cell)

the end angle (360 for a omni cell)

Due to the nature of the TA value the difference between the inner and outer circle (the depth) will be approximately 550 meters when used. It is not possible to give a specific value for the accuracy since it depends on several things like:

If it is an omni cell or a sector cell

The area of the arc changes, depending on the distance to the BTS (the TA value is quite stable though)

The dispersion, which can give a higher TA value, compared to if there was line-of-sight between the MS and the BTS.

The WM-server is accessible via a web interface or a mobile station.

The user or any other person with access to the messaging application running on the WM-server will here be called the programmer.

The mobile network thus comprises means, i.e. the WM server 12, programmable by a programmer to alert a specific mobile station when the mobile station passes within a predetermined range from a specific geographical location, and means, i.e. the base station system 3, for disclosing to the mobile station whatever message information the programmer chose to associate with the specific geographical location.

The message tool is a graphical user interface (GUI) which can be used to configure the message application. The GUI communicates with the WM server through HTTP/HTTPS.

To gain access to the message tool, the programmer must log in by specifying a user id and a corresponding password. This prevents unauthorised access to the message tool.

The programmers can be assigned different groups, thus giving them access to different functions in the message tool.

A geographical map-database is incorporated in or connected to (not shown) the WM-server in order to “match” the desired location with the actual current location. The geographical map-database may contain other information than the geographical location of street addresses, e.g. “points of interest” such as cities, airports, roads, hospitals, museums, restaurants, banks, hotels, and other geographical landmarks, such as mailboxes and grocery stores etc. The common part of the geographical map-database is updated centrally with e.g. “points of interest” of the kind mentioned above which means that these updates are done automatically without the user having to pay any attention to changes in this information.

The present invention can be used as an extension of the calendar function (for example Microsoft Outlook) in a work or home computer. This makes it possible to send reminder messages based on entries in the calendar. It is of course required that the work or home computer is connected to the WM server 12 in the switching system of the mobile network via e.g. the Internet or the mobile network. This is a useful way of delivering documents etc to the user when and where they are needed.

The present invention can also be used for entering ‘wireless waypoints’ when passing an interesting place, e.g. when you want to be reminded of a good coffee shop the next time you are close by. These ‘wireless waypoints’ could be entered via the MS either by sending an SMS to the WM-server. 12 or by accessing the WM-server via mobile internet. The ‘wireless waypoints’ can then be edited and associated with a message by the programmer, who in this case probably is the user, by accessing the message information via a web-interface.

The present invention can further be used for defining groups of users that can receive the same message depending on which user, or users, in the group meet all criteria, e.g. geographical location, which is associated with that particular message. In this way e.g. access codes could be sent to group members when they arrive at a certain destination where the access code, e.g. a key code or password for a locked door, is needed. It is also possible that the message information, i.e. at least one access code, is sent to at least one user when the user arrives at a certain destination where the access code, e.g. a key code or password for a locked door, is needed. If a family is a group of users, the message could be ‘Buy milk’ and the criteria could be “after leaving the day care center”. In this case the user, i.e. the parent, who does not pick up the children from the day care center will not receive the message and will not have to worry about buying milk. It is also possible to define that only the first person passing a specific location will receive a message. It is also possible to define that one person in a group receives a message, i.e. that message information is sent to one person in a group when another person in the group passes a specific location, e.g. the father in the family receives the message “call wife” when the mother in the family arrives at work.

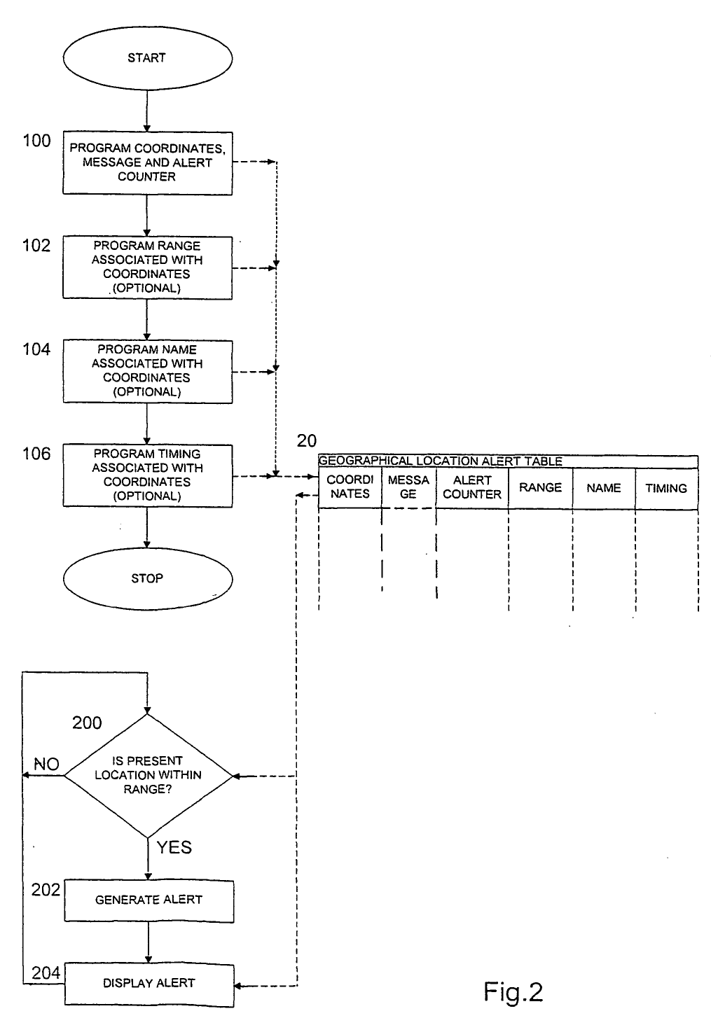

FIG. 2 shows a schematic flow diagram of operations performed when programming the message tool in the message application run on the WM-server.

Firstly 100, in the method of sending messages to users in the mobile network based on geographical location, the programmer is requested to program the network to alert a specific mobile station when the mobile station passes within a predetermined range from a specific geographical location by creating, deleting or changing an entry of a geographical location, geographical location information, in a geographical location alert table 20 by e.g. clicking with a mouse on the location on the map, or choose type of “point of interest” from a drop down menu, which is presented by the geographical map-database, and also to associate a specific message, i.e. message information, with the specific geographical location by creating, deleting or changing an entry of a message information the programmer associates with this geographical location, and further to determine how many times, i.e. the number of passes, the mobile station shall receive the alert and thus said message information associated with the specific geographical location by programming, i.e. creating deleting or changing an entry of an alert alert counter information the programmer associates with this message information. In this way the programmer can chose for how many passes for a specific location a reminder message should be valid. For instance, if the programmer would like to be reminded of posting a letter, this message should only be valid when the user passes a mailbox the first time after entering the message, i.e. the message is only sent the first time the user passes after the message is entered. In this case the alert counter is set to 1 by the programmer. Each time an alert is sent to the mobile station, the alert counter steps down one step, e.g. from 5 to 4. When the alert counter reaches the value 0 the message information is automatically deleted from the geographical location alert table if not otherwise specified. Default is that the message is valid once, but there could also be other options such as a specific number of passes, e.g. 5 passes, or until the message information is cancelled by the user, i.e. the message is sent each time the user passes the geographical location. This could be chosen from a drop down menu. Passing a geographical location means in this application passing by, i.e. entering or leaving the area defined as the location. By default the alert is triggered when entering the area of a location. When leaving a location it could be of use to be reminded of e.g. a check-list with things to do and collect before leaving the location. The alert is triggered either when entering or when leaving, i.e. only once each time the mobile station passes the location.

Secondly 102, the programmer is requested to create, delete or change an entry of range information, e.g. 100 meters from the geographical location, which the programmer wishes to associate with the geographical location, which range information will trigger an alert when the mobile terminal passes within this range of the geographical location associated with the range information This step is optional.

If no range is chosen, a predefined standard range, e.g. 150 meters, is set.

Thirdly 104, the programmer is requested to create, delete or change an entry of name information, e.g. a name such as “post office”, which the programmer wishes to associate with the geographical location. This step is optional. This could also be chosen from a predefined drop down menu or equivalent.

Fourthly 106, the programmer is requested to program, i.e. to create, delete or change an entry of timing information, i.e. a) time of day, i.e. before a specific point of time, at a specific point of time, after a specific point of time or between two specific points of time and/or b) date, i.e. before a specific date, at a specific date, after a specific date or between two specific dates, which timing information the programmer wishes to associate with the geographical location, which timing information will decide if an alert is triggered when the mobile terminal passes within range of the geographical location associated with the timing information. This step is optional. If no timing information is set, a time span of 24 hours a day seven days a week is set.

When determining (200) an actual geographical location of the mobile station by using the capability of the mobile network, the geographical coordinates information in the geographical location alert table together with identification information for the specific mobile station, such as the telephone number or equivalent, and a message identification number, message id-number, is sent from the WM server to the MPS system. If the programmer has chosen a point of interest such as “mailbox” the list of geographical coordinates could be rather long, e.g. all mailboxes in Sweden. In this case it is advisable to limit the list based on the last known position of the mobile station. The MPS system their checks the present position of the mobile station versus the positions received from the geographical location alert table. When the present position of the mobile station matches one of these received positions, the MPS system sends an alert generation message to the WM server which message contains information which message to send, i.e. message id-number, and to which user, e.g. telephone number.

FIG. 2 shows further a schematic flow diagram of operations performed in a digital telephone system according to FIG. 1 when alerting a mobile station. When the geographical alert table is not empty, the mobile network determines 200 if the present actual geographical location of the mobile terminal is within range of coordinates of any geographical location appearing in the geographical location alert table 20 as described above. When a mobile terminal passes within that range of a geographical location it will trigger the alert for the geographical location and generate 202 an alert e.g. by sending an SMS (Short message service) message. When using Short message service (SMS), the WM-server will send the messages either directly to the ME or is via the MSC/VLR to the ME. From the MXE the message will be forwarded to the specific mobile terminal.

The mobile station may then display 204 the alert by e.g. emitting a sound or vibrate or display on display that an SMS message has been received, in this way expressing on the mobile station whatever message information the programmer chose to associate with the specific geographical location.

The invention is described using the Ericsson 3.0 MPS as an example, but the invention is also applicable in other mobile network Mobile Positioning Systems.

The invention is described using a GSM system as an example, but the invention is also applicable in packet switched systems, e.g. GPRS, EDGE, UMTS, etc.

1. A mobile network comprising means for sending a specific message to a specific mobile station in the mobile network based on geographical location, characterised in that the mobile network is used to determine the actual geographical location of the specific mobile station, and where the network comprises means (12) programmable by a programmer to alert a specific mobile station when the mobile station passes within a predetermined range from a specific geographical location, means (3) for disclosing to the mobile station whatever message information the programmer chose to associate with the specific geographical location, and means (12) programmable by a programmer to define the number of passes the mobile station shall receive said message information.

2. A mobile network according to claim 1, characterised in that a message sending means comprises a WM server (12) which is part of the switching system (1) in the mobile network.

3. A mobile network according to claim 2, characterised in that the WM server (12) is able to communicate with a Mobile Positioning system (MPS) (14) to find out the location of the mobile station

4. A mobile network according to claim 2 or 3, characterised in that the WM server (12) is accessible via a web interface and/or a mobile station.

5. A mobile network according to any of claims 2 to 4, characterised in that a geographical map-database is connected to or incorporated in the WM server (12).

6. A mobile network according to any of claims 1 to 5, characterised in that the mobile network is a GSM network.

7. A mobile network according to any of claims 1 to 6, characterised in that the message information the programmer chose to associate with the specific geographical location is disclosed to the mobile station in an SMS (Short message service) message.

8. A mobile network according to any of claims 1 to 7, characterised in that the message information the programmer chose to associate with the specific geographical location is based on entries in a calendar.

9. A method of sending messages to users in a mobile network based on geographical location, comprising the steps of:
programming the network to alert a specific mobile station when the mobile station passes within a predetermined range from a specific geographical location (100, 102),
associating information with the specific geographical location (100, 102, 104, 106),
associating an alert counter with a message information, which alert counter defines the number of passes the mobile station shall receive said message information,
expressing (204) on the mobile station whatever message information the programmer chose to associate with the specific geographical location when the mobile station arrives at, or within a predetermined range from, the specific geographical location.

10. A method of sending messages to users in a mobile network based on geographical location according to claim 9, where the steps of determining (200) an actual geographical location of the mobile station by using the capability of the mobile network, and checking the present position of the mobile station versus said specific geographical location, comprises the steps of:
sending geographical coordinates information from a geographical location alert table together with identification information for a specific mobile station and a message identification number, from a WM server to a MPS system,
checking in the MPS system the present position of the mobile station versus the positions received from the geographical location alert table, and
sending an alert generation message from the MPS system to the WM server containing information about which message to send, and to which mobile station when the present position of the mobile station matches one of the positions received from the geographical location alert table.

11. A method of sending messages to users in a mobile network based on geographical location according to claim 9 or 10, comprising the step of sending message information to a predefined group of users.

12. A method of sending messages to users in a mobile network based on geographical location according to any of claims 9 to 11, comprising the step of sending message information to one person in a group when another person in the group passes a specific location.

13. A method of sending messages to users in a mobile network based on geographical location according to any of claims 9 to 12, wherein the message information comprises at least one access code and which code is sent to at least one user when the user arrives at a certain destination where the access code, e.g. a key code or password for a locked door, is needed.

14. A method of sending messages to users in a mobile network based on geographical location according to any of claims 9 to 13, wherein the message is only sent the first time the user passes after the message is entered.

15. A method of sending messages to users in a mobile network based on geographical location according to any of claims 9 to 13, wherein the message is sent each time the user passes the geographical location.

16. A method of sending messages to users in a mobile network based on geographical location according to claim 15, wherein the message is sent each time the user enters the geographical location.

17. A method of sending messages to users in a mobile network based on geographical location according to claim 15, wherein the message is sent each time the user leaves the geographical location.

18. A method of sending messages to users in a mobile network based on geographical location according to any of claims 9 to 17, comprising the step of programming timing information which timing information will decide if an alert is triggered when the mobile station passes within range from the geographical location associated with the timing information.

19. A method of sending messages to users in a mobile network based on geographical location according to claim 18, where the timing information will trigger an alert before a specific point of time of day.

20. A method of sending messages to users in a mobile network based on geographical location according to claim 18, where the timing information will trigger an alert at a specific point of time of day.

21. A method of sending messages to users in a mobile network based on geographical location according to claim 18, where the timing information will trigger an alert after a specific point of time of day.

22. A method of sending messages to users in a mobile network based on geographical location according to claim 18, where the timing information will trigger an alert between two specific points of time of day.

23 A method of sending messages to users in a mobile network based on geographical location according to claim 18, where the timing information will trigger an alert before a specific date.

24. A method of sending messages to users in a mobile network based on geographical location according to claim 18, where the timing information will trigger an alert at a specific date.

25. A method of sending messages to users in a mobile network based on geographical location according to claim 18, where the timing information will trigger an alert after a specific date.

26. A method of sending messages to users in a mobile network based on geographical location according to claim 18, where the timing information will trigger an alert between two specific dates.
